(19) United States
(12) Patent Application Publication
(10) Pub. No.: US 2026/0120325 A1
(43) Pub. Date: Apr. 30, 2026

(54) METHOD OF ENCODING/DECODING DYNAMIC MESH AND RECORDING MEDIUM STORING METHOD OF ENCODING/DECODING DYNAMIC MESH

(71) Applicant: Electronics and Telecommunications Research Institute, Daejeon (KR)

(72) Inventors: Da Yun NAM, Daejeon (KR); Seong Yong LIM, Daejeon (KR); Hyun Cheol KIM, Daejeon (KR); Chae Eun RHEE, Incheon (KR); Yong Wook SEO, Incheon (KR); Hyun Min JUNG, Incheon (KR)

(73) Assignee: Electronics and Telecommunications Research Institute, Daejeon (KR)

(21) Appl. No.: 19/003,787

(22) Filed: Dec. 27, 2024

(30) Foreign Application Priority Data
Dec. 27, 2023 (KR) 10-2023-0192512
Jan. 16, 2024 (KR) 10-2024-0007051
Jun. 10, 2024 (KR) 10-2024-0075237
Dec. 26, 2024 (KR) 10-2024-0197056

(51) Int. Cl. G06T 9/00; G06T 17/00

(52) U.S. Cl. CPC G06T 9/001; G06T 17/00

(57) ABSTRACT

A method of decoding a dynamic mesh includes decoding a base mesh; subdividing the base mesh; decoding displacement information; and reconstructing a mesh by applying the displacement information to a subdivided mesh. In this instance, a 3-dimensional subdivision type of the base mesh is determined based on mesh subdivision information decoded from a bitstream, and a 2-dimensional subdivision type for a 2D coordinate is determined based on the 3D subdivision type for the base mesh.

### BACKGROUND OF THE INVENTION

### Field of the Invention

The present disclosure relates to a method of encoding/decoding a dynamic mesh.

### Description of the Related Art

Static or dynamic 2D data may generally be encoded/decoded using image or video compression codecs such as AVC, HEVC or VVC. Due to high compression performance of the compression codecs, a method of using the compression codecs to compress immersive video or mesh has continuously been studied.

### SUMMARY OF THE INVENTION

It is another object of the present disclosure to provide a method of subdividing a base mesh generated through mesh simplification when encoding/decoding a dynamic mesh.

It is a further object of the present disclosure to provide a method of subdividing a base mesh based on a plurality of mesh subdivision type candidates.

It is a further object of the present disclosure to provide a method of variably setting a mesh subdivision type for each subdivision iteration.

It is a further object of the present disclosure to provide a method of determining subdivision type of 3D vertexes and 2D texture coordinates.

It is a further object of the present disclosure to provide a method for partitioning a mesh into a plurality of sub-meshes in encoding/decoding a dynamic mesh.

It is a further object of the present disclosure to provide a method for determining an encoding type for each sub-mesh in encoding/decoding a dynamic mesh.

It is a further object of the present disclosure to provide a method for adjusting the size and/or position of a bounding box for determining an encoding type in encoding/decoding a dynamic mesh.

The technical problems to be achieved by the present disclosure are not limited to the technical problems mentioned above, and other technical problems not mentioned herein may be clearly understood by those skilled in the art from the description below.

In accordance with an aspect of the present disclosure, the above and other objects can be accomplished by the provision of a method of decoding a dynamic mesh, the method including decoding a base mesh; subdividing the base mesh; decoding displacement information; and reconstructing a mesh by applying the displacement information to a subdivided mesh. In this instance, a 3-dimensional subdivision type of the base mesh is determined based on mesh subdivision information decoded from a bitstream, and a 2-dimensional subdivision type for a 2D coordinate is determined based on the 3D subdivision type for the base mesh.

In the method of decoding the dynamic mesh according to the present disclosure, when the 3D subdivision type is a midpoint subdivision or the loop subdivision, the 2D subdivision type is the same as the 3D subdivision type.

In the method of decoding the dynamic mesh according to the present disclosure, when the 3D subdivision type is not the midpoint subdivision and the loop subdivision, the 2D subdivision type is determined as a default subdivision type.

In the method of decoding the dynamic mesh according to the present disclosure, the default subdivision type is the midpoint subdivision.

In the method of decoding the dynamic mesh according to the present disclosure, the mesh subdivision information comprises an index specifying one of a plurality of mesh subdivision type candidates.

In the method of decoding the dynamic mesh according to the present disclosure, the plurality of mesh subdivision type candidates comprises at least one of a midpoint subdivision, a loop subdivision, a LS3 subdivision, a normal subdivision or a PYTHAG subdivision.

In the method of decoding the dynamic mesh according to the present disclosure, subdivision iteration information indicating a number of subdivision iterations of a mesh is further decoded from the bitstream, and when a current subdivision iteration index is less than the number of subdivision iterations indicated by the subdivision iteration information, the mesh subdivision information is decoded.

In accordance with another aspect of the present disclosure, there is provided a method of decoding a dynamic mesh, the method including generating a base mesh through a mesh decimation; subdividing the base mesh; extracting displacement information for a subdivided mesh; and encoding the base mesh and the displacement information. In this instance, mesh subdivision information indicating a 3-dimensional subdivision type of the base mesh is encoded into a bitstream, and a 2-dimensional subdivision type for a 2D coordinate is determined based on the 3D subdivision type for the base mesh.

In the method of encoding the dynamic mesh according to the present disclosure, when the 3D subdivision type is a midpoint subdivision or the loop subdivision, the 2D subdivision type is the same as the 3D subdivision type.

In the method of encoding the dynamic mesh according to the present disclosure, when the 3D subdivision type is not the midpoint subdivision and the loop subdivision, the 2D subdivision type is determined as a default subdivision type.

In the method of encoding the dynamic mesh according to the present disclosure, the default subdivision type is the midpoint subdivision.

In the method of encoding the dynamic mesh according to the present disclosure, the mesh subdivision information comprises an index specifying one of a plurality of mesh subdivision type candidates.

In the method of encoding the dynamic mesh according to the present disclosure, the plurality of mesh subdivision type candidates comprises at least one of a midpoint subdivision, a loop subdivision, a LS3 subdivision, a normal subdivision or a PYTHAG subdivision.

In the method of encoding the dynamic mesh according to the present disclosure, subdivision iteration information indicating a number of subdivision iterations of a mesh is further encoded into the bitstream, and when a current subdivision iteration index is less than the number of subdivision iterations indicated by the subdivision iteration information, the mesh subdivision information is encoded.

Meanwhile, in the present disclosure, it is possible to provide a computer-readable recording medium recording the method of encoding/decoding the dynamic mesh.

The technical problems to be achieved in the present disclosure are not limited to the technical problems mentioned above, and other technical problems not mentioned herein may be clearly understood by those skilled in the art from the description below.

### BRIEF DESCRIPTION OF THE DRAWINGS

The above and other objects, features and other advantages of the present disclosure will be more clearly understood from the following detailed description taken in conjunction with the accompanying drawings, in which:

FIG. 1 is a block diagram of an encoder for encoding a dynamic mesh;

FIG. 2 is a block diagram of a decoder for decoding the dynamic mesh;

FIGS. 3 and 4 illustrate examples in which additional vertices are created by midpoint subdivision;

FIG. 5 illustrates comparing examples of cases where the mesh division type is independently determined for each division round and cases where it is not.

FIG. 6 illustrates an example in which a fixed mesh subdivision type is used for each iteration;

FIGS. 7 and 8 are drawings for explaining a loop subdivision method.

FIG. 9 shows an example in which LS3 subdivision is applied.

FIG. 10 shows an example in which multiple subdivision type candidates are selectively applied during the encoding process of a dynamic mesh.

FIG. 11 illustrates a refined mesh output through an in-loop filter;

FIG. 12 is a diagram for describing a time point when the in-loop filter is applied;

FIG. 13 illustrates an example in which the in-loop filter is applied to a reconstructed mesh;

FIG. 14 is a flowchart of a method of encoding the dynamic mesh according to an embodiment of the present disclosure; and

FIG. 15 is a flowchart of a method of decoding the dynamic mesh according to an embodiment of the present disclosure.

FIG. 16 illustrates an example in which the encoding type of a frame, designed to be encoded/decoded as P type, is determined as I type.

FIG. 17 shows an example in which a mesh is partitioned into a plurality of regions.

FIG. 18 is a diagram for describing an example in which distortion due to a cross-section occurs at a boundary between sub-meshes.

FIG. 19 shows an example in which the size of a bounding box is adjusted.

FIG. 20 shows an example in which the position of a bounding box is adjusted.

FIGS. 21 and 22 are an example of a mesh encoding/decoding method according to an embodiment of the present disclosure.

### DETAILED DESCRIPTION OF THE INVENTION

Since the present disclosure may be variously changed and have several embodiments, specific embodiments are illustrated in drawings and are described in detail in a detailed description. However, this is not to limit the present disclosure to a specific embodiment, and should be understood as including all changes, equivalents and substitutes included in an idea and a technical scope of the present disclosure. A similar reference numeral in a drawing refers to a like or similar function across multiple aspects. A shape and a size, etc. of elements in a drawing may be exaggerated for a clearer description. A detailed description on exemplary embodiments described below refers to an accompanying drawing which shows a specific embodiment as an example. These embodiments are described in detail so that those skilled in the pertinent art can implement an embodiment. It should be understood that a variety of embodiments are different each other, but do not need to be mutually exclusive. For example, a specific shape, structure and characteristic described herein may be implemented in other embodiments without departing from a scope and a spirit of the present disclosure in connection with an embodiment. In addition, it should be understood that a position or arrangement of an individual element in each disclosed embodiment may be changed without departing from a scope and a spirit of an embodiment. Accordingly, a detailed description described below is not taken as a limited meaning and a scope of exemplary embodiments, if properly described, are limited only by an accompanying claim along with any scope equivalent to that claimed by those claims.

In the present disclosure, terms such as first, second, etc. may be used to describe a variety of elements, but the elements should not be limited by the terms. The terms are used only to distinguish one element from another element. For example, without departing from a scope of a right of the present disclosure, a first element may be referred to as a second element and likewise, a second element may be also referred to as a first element. A term of and/or includes a combination of a plurality of relevant described items or any item of a plurality of relevant described items.

When an element in the present disclosure is referred to as being “connected” or “linked” to another element, it should be understood that the element may be directly connected or linked to that another element, but there may be another element therebetween. Meanwhile, when an element is referred to as being “directly connected” or “directly linked” to another element, it should be understood that there is no other element therebetween.

As construction units shown in an embodiment of the present disclosure are independently shown to represent different characteristic functions, it does not mean that each construction unit is composed in a construction unit of separate hardware or one piece of software. In other words, as each construction unit is included by being enumerated as each construction unit for convenience of a description, at least two construction units of each construction unit may be combined to form one construction unit or one construction unit may be subdivided into a plurality of construction units to perform a function, and an integrated embodiment and a separate embodiment of each construction unit are also included in a scope of a right of the present disclosure unless they are beyond the essence of the present disclosure.

A term used in the present disclosure is merely used to describe a specific embodiment, and is not intended to limit the present disclosure. A singular expression, unless the context clearly indicates otherwise, includes a plural expression. In the present disclosure, it should be understood that a term such as “include” or “have”, etc. is merely intended to designate the presence of a feature, a number, a step, an operation, an element, a part or a combination thereof described in the present specification, and does not preclude a possibility of presence or addition of one or more other features, numbers, steps, operations, elements, parts or their combinations. In other words, a description of “including” a specific configuration in the present disclosure does not exclude a configuration other than a corresponding configuration, and it means that an additional configuration may be included in a scope of a technical idea of the present disclosure or an embodiment of the present disclosure.

Some elements of the present disclosure are not necessary elements which perform an essential function in the present disclosure and may be optional elements for merely improving performance. The present disclosure may be implemented by including only a construction unit which is necessary to implement essence of the present disclosure except for an element merely used for performance improvement, and a structure including only a necessary element except for an optional element merely used for performance improvement is also included in a scope of a right of the present disclosure.

Hereinafter, an embodiment of the present disclosure is described in detail by referring to the drawings. In describing an embodiment of the present specification, when it is determined that a detailed description on a relevant disclosed configuration or function may obscure a gist of the present specification, such a detailed description is omitted, and the same reference numeral is used for the same element in the drawings and an overlapping description on the same element is omitted.

A dynamic mesh, which is volumetric media, may be compressed by distinguishing between geometric information and attribute information. Specifically, geometric information and attribute information of the dynamic mesh may be encoded/decoded, respectively. The geometric information may comprise vertexes constituting the dynamic mesh, connecting relationship between vertexes and information on faces. Here, a face may have a triangular shape including three vertices. The attribute information may comprise a normal vector, a texture map mapping coordinate and face attribute information.

The geometric information represents a position of a vertex in a three-dimensional (3D) space and may be expressed in the form of a displacement vector. The attribute information may represent texture, etc.

The attribute information of the dynamic mesh may be encoded/decoded through a general video codec, such as HEVC, VVC, or AV1.

The geometric information of each vertex may be encoded/decoded separately from the attribute information. However, since the number of vertices included in the mesh is significantly large, encoding/decoding thereof without change has a problem of lowering compression efficiency. Accordingly, mesh decimation and mesh subdivision techniques may be applied to encode/decode the geometric information.

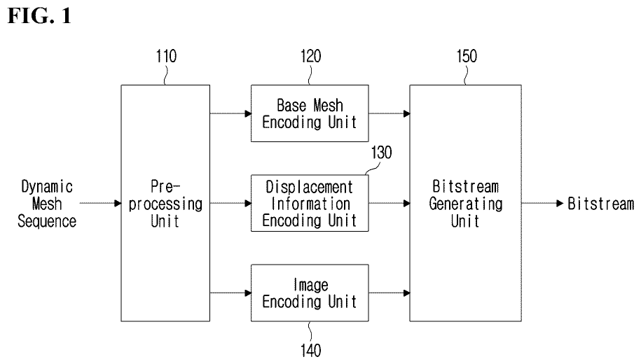

FIG. 1 is a block diagram of an encoder for encoding a dynamic mesh.

Referring to FIG. 1, the encoder may include a pre-processing unit 110, a base mesh encoding unit 120, a displacement information encoding unit 130, an image encoding unit 140, and a bitstream generating unit 150.

The pre-processing unit 110 performs mesh decimation on dynamic mesh input. Mesh decimation refers to reducing the number of vertices included in the mesh to reduce the amount of data to be encoded/decoded. Through mesh decimation, a base mesh, which is a basic structure of a mesh, may be generated. That is, the base mesh may have fewer vertices and faces than those of an original mesh. Meanwhile, a vertex included in the base mesh may be referred to as a basic vertex.

However, as the number of vertices included in the mesh decreases, mesh restoration quality in the decoder more deteriorates. To reduce this problem, additional vertices may be generated by applying mesh subdivision technique to the base mesh. A subdivided mesh may include an additional vertex generated through mesh subdivision in addition to basic vertices.

The pre-processing unit 110 may generate an atlas by packing attribute information of each face included in the mesh in a 2D image. Further, the preprocessor 110 may generate mapping information between a face packed in the atlas and a face of the subdivided mesh. Meanwhile, each of faces packed in the atlas may be referred to as a patch.

The pre-processing unit 110 may generate displacement information for the subdivided mesh. The displacement information may include a displacement vector representing a difference between a position of a vertex in the subdivided mesh and a position of a corresponding vertex in a fitted mesh. The fitted mesh may be an approximated one to resemble the original mesh.

The base mesh encoding unit 120, the displacement information encoding unit 130, and the image encoder 140 each encode data generated through the pre-processing unit 110.

Specifically, the base mesh encoding unit 120 encodes the base mesh generated in the preprocessing unit 110.

Meanwhile, the base mesh may be encoded through an intra mode or an inter mode. When the inter mode is applied, a base mesh of a current frame may be derived based on a base mesh of a reference frame. Specifically, by compensating for motion of each vertex in the base mesh of the reference frame, the base mesh for the current frame may be derived.

When the base mesh is encoded in the inter mode, motion information may be encoded and signaled.

The displacement information encoding unit 130 encodes displacement information about vertices included in the subdivided mesh. Here, the displacement information is used to determine a position of a vertex in a 3D space and may include a displacement vector. The displacement vector represents a difference between a current position of a vertex in the subdivided mesh and a position of the corresponding vertex in the fitted mesh.

The image encoding unit 140 encodes attribute information. As an example, the image encoding unit 140 may encode an atlas in which faces of a mesh are packed.

Meanwhile, the displacement information encoding unit 130 and the image encoding unit 140 may operate based on codec technology such as VVC, HEVC, or AV1.

The bitstream generating unit 150 multiplexes the encoded data and generates a bitstream.

Meanwhile, metadata may be generated and encoded so that a reverse process of a preprocessing process performed in the pre-processing unit 110 of the encoder may be performed. The bitstream may further include the metadata.

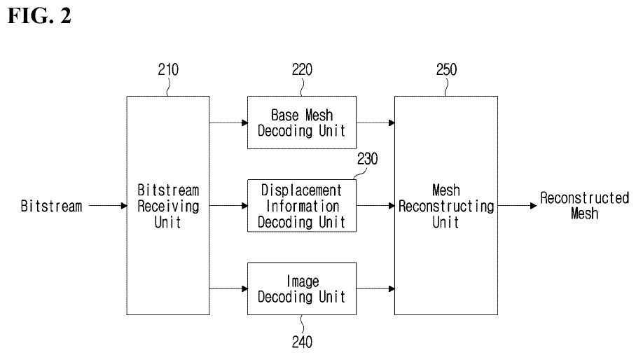

Referring to FIG. 2, the decoder may include a bitstream receiving unit 210, a base mesh decoding unit 220, a displacement information decoding unit 230, an image decoding unit 240, and a mesh reconstruction unit 250.

The bitstream receiving unit 210 demultiplexes the received bitstream and derives a plurality of pieces of encoded data. As an example, encoded attribute data, encoded base mesh data, and encoded geometry data may be derived through bitstream demultiplexing.

The base mesh decoding unit 220 decodes the encoded base mesh. Meanwhile, the base mesh may be decoded through the intra mode or the inter mode. When the inter mode is applied, the base mesh of the current frame may be derived based on the base mesh of the reference frame.

The displacement information decoding unit 230 decodes the encoded displacement information. The displacement information is used to determine a position of a vertex in the 3D space and may include a displacement vector.

The image decoding unit 240 decodes the attribute information. As an example, the image decoding unit 240 may decode an atlas in which a plurality of patches is packed.

The mesh reconstruction unit 250 performs mesh subdivision on the decoded base mesh, adds the displacement information to the subdivided mesh, and restores the geometric information of the mesh. In addition, the mesh reconstructing unit 250 may reconstruct the mesh by adding decoded attribute information to the mesh.

As described above, by creating a base mesh through mesh decimation and encoding/decoding the base mesh instead of the original mesh, data that needs to be encoded/decoded may be reduced. However, when the mesh is restored using only the base mesh, a problem occurs in which quality of the restored mesh deteriorates. To prevent the above problem, additional vertices may be generated by performing mesh subdivision on the base mesh. In the decoder, additional vertices may be generated by performing mesh subdivision on the base mesh using the same method as that for the encoder.

To perform mesh subdivision in the decoder using the same method as that for the encoder, information about a mesh subdivision type used in the encoder may be encoded and signaled.

The information about the mesh subdivision type may include at least one of information indicating whether mesh subdivision has been performed on the base mesh or information for identifying a mesh subdivision method applied to the base mesh among a plurality of mesh subdivision method candidates.

Meanwhile, in the encoder and the decoder, mesh subdivision on the base mesh may be performed using a default mesh subdivision type. In this case, only information indicating whether mesh subdivision has been performed on the base mesh may be encoded and signaled. As an example, Table 1 shows an example of a method in which mesh subdivision is indicated according to a value of syntax asve_subdivision_method.

TABLE 1

| asve_subdivision_method | Name of subdivision method |
|---|---|
| 0 | NONE |
| 1 | MIDPOINT |

As illustrated in Table 1, when mesh subdivision is not applied to the base mesh, encoding may be performed by setting the value of syntax asve_subdivision_method to 0. On the other hand, when mesh subdivision is applied to the base mesh, encoding may be performed by setting the value of syntax asve_subdivision_method to 1.

The default subdivision method may be midpoint subdivision, as in the example of Table 1.

Meanwhile, the value of asve_subdivision_method does not necessarily have to be 0 or 1. For example, the range of values that asve_subdivision_method may take, 2 to 7, may be reserved for future use.

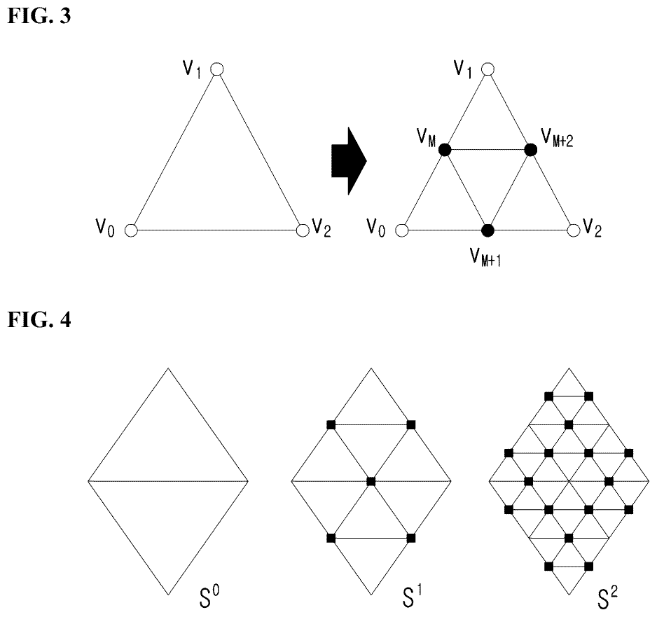

FIGS. 3 and 4 illustrate examples in which additional vertices are generated by midpoint subdivision.

As in the example shown in FIG. 3, when midpoint subdivision is applied, a center position between two adjacent vertices may be set as an additional vertex. As an example, as in the example shown in FIG. 3, an additional vertex v_{M} may be generated at a midpoint of v₀ and v₁, an additional vertex v_{M+1} may be generated at a midpoint of v₀ and v₂, and an additional vertex v_{M+2} may be generated at a midpoint of v₁ and v₂.

When additional vertices are generated, a new polygon may be constructed by constructing connecting lines between the additional vertices.

Meanwhile, mesh subdivision may be repeatedly performed until enough vertices are generated. For example, as in the example shown in FIG. 4, midpoint subdivision may be applied twice (S¹ and S²) based on midpoint subdivision.

Mesh subdivision may be performed using a mesh subdivision type other than the default mesh subdivision type. In this instance, the mesh subdivision type candidates that may be selected by the encoder and the decoder include at least one of midpoint subdivision, loop subdivision, butterfly subdivision, or LS3 (Lease Square Subdivision Surfaces).

In this case, a range of values that syntax asve_subdivision_method may have is increased as shown in Table 2 to determine whether mesh subdivision has been performed on the base mesh and the mesh subdivision type.

TABLE 2

| asve_subdivision_method | Name of subdivision method |
|---|---|
| 0 | NONE |
| 1 | MIDPOINT |
| 2 | Loop |
| 3 | Butterfly |
| 4 | LS3 |
| 5 | Reserved |

As in the example of Table 2, when the value of syntax asve_subdivision_method is 0, the value indicates that mesh subdivision has not been performed on the base mesh. On the other hand, when the value of syntax asve_subdivision_method is 1 or more, the value indicates that mesh subdivision has been performed on the base mesh. When the value of syntax asve_subdivision_method is not 0, one of the plurality of mesh subdivision type candidates may be selected according to the value of syntax asve_subdivision_method.

As another example, information indicating whether mesh subdivision is performed on the base mesh and information indicating the subdivision type of the mesh may be encoded/decoded using separate syntax. In this case, information indicating one of the plurality of mesh subdivision method candidates may be encoded/decoded only when mesh subdivision is performed on the base mesh.

As an example, syntax vdmc_subdivision_enable_flag indicating whether mesh subdivision has been performed on the base mesh may be encoded/decoded. When the value of syntax vdmc_subvidison_enable_flag is 1, the value indicates that mesh subdivision has been performed on the base mesh. In this case, syntax asve_subdivision_method indicating the mesh subdivision type may be encoded/decoded. Syntax asve_subdivision_method may indicate one of a plurality of subdivision type candidates.

Meanwhile, when mesh subdivision is applied to the base mesh, information about the number of mesh subdivisions may be additionally encoded/decoded. As an example, syntax asve_subdivision_iteration_count indicates the number of subdivisions of the base mesh.

Alternatively, syntax asve_subdivision_iteration_count_minus1, which is derived by subtracting 1 from the number of subdivisions of the mesh, may be encoded/decoded.

Meanwhile, it is also possible to omit encoding/decoding of information (e.g., syntax vdmc_subvidision_enabled_flag) indicating whether the base mesh is divided, and determine whether the base mesh is divided or not based on the number of times the mesh is divided. For example, if the syntax asve_subdivision_iteration_count is 0, it indicates that the base mesh is not divided. On the other hand, if the syntax asve_subdivision_iteration_count is greater than 0, it indicates that the base mesh is divided.

For the base mesh, when mesh subdivision is performed a plurality of times, the mesh subdivision types over a plurality of iterations may be the same. That is, when the mesh subdivision type for the base mesh is determined by asve_subdivision_method, the determined mesh subdivision type may be commonly applied to repeated subdivision iterations.

Table 3 shows the syntax structure when a single mesh subdivision type for the basic mesh is applied to a multiple iterations.

TABLE 3

| | Descriptor |
|---|---|
| asps_vdmc_extension( ) { | |
| asve_subdivision_method | u(3) |
| if(asve_subdivision_method != 0) { | |
| asve_subdivision_iteration_count | u(8) |
| AspsSubdivisionCount = asve_subdivision_iteration_count | |
| } else | |
| AspsSubdivisionCount = 0 | |

As in the example shown in Table 3, if the syntax asve_subdivision_method indicates other than ‘NONE’ in Table 2, that is, if the value of the syntax asve_subdivision_method is greater than 0, the syntax asve_subdivision_iteration_count indicating the number of subdivisions may be encoded/decoded.

Alternatively, when mesh subdivision is performed a plurality of times on the base mesh, the mesh subdivision type may be individually determined for each iteration. In this case, syntax asve_subdivision_method indicating the mesh subdivision type may be encoded/decoded at each iteration.

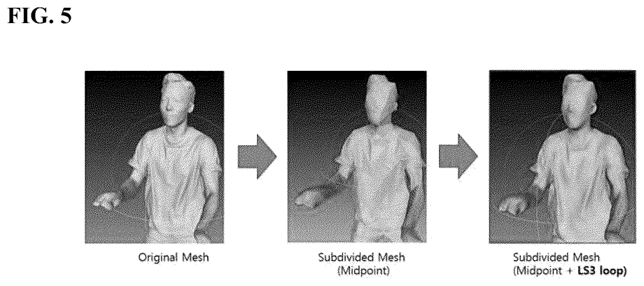

FIG. 5 illustrates comparing examples of cases where the mesh division type is independently determined for each division round and cases where it is not.

The middle of FIG. 5 shows an example where the midpoint subdivision is applied to all iterations when subdividing the original mesh, and the right of FIG. 5 shows an example where the midpoint subdivision is applied to the first iteration and LS3 subdivision is applied to the second iteration while dividing the original mesh.

Table 4 shows a syntax table structure in which the mesh subdivision type is encoded/decoded for each iteration.

TABLE 4

| | Descriptor |
|---|---|
| asps_vdmc_extension( ) { | |
| vdmc_subdivision_enable_flag | u(1) |
| if(vdmc_subdivision_enable_flag){ | |
| asve_subdivision_iteration_count | u(8) |
| if(asve_subdivision_iteration_count >0){ | |
| for(i=0; i< | |
| asve_subdivision_iteration_count; i++){ | |
| asve_subdivition_method[ i ] | u(3) |
| } | |
| AspsSubdivisionCount = asve_subdivision_iteration_c | |
| ount | |
| } else | |
| AspsSubdivisionCount = 0 | |
| } | |
| } | |

In Table 4, it is illustrated that, the number of mesh subdivisions is determined based on syntax asve_subdivision_iteration_count. In addition, when the number of subdivisions is determined by asve_subdivision_iteration_count, asve_subdivision_method[i] is encoded/decoded for each iteration. Here, i represents the subdivision iteration and may fall within a range from 0 to (asve_subdivision_iteration_count−1).

Meanwhile, since the number of subdivision iterations is determined by asve_subdivision_iteration_count, the value of the syntax asve_subdivision_method does not need to indicate whether or not to perform subdivision. Accordingly, if the syntax asve_subdivision_iteration_count, indicating the number of subdivision iterations, is encoded/decoded before the syntax asve_subdivision_method, indicating the subdivision method, no subdivision (i.e., None) may not be used as a subdivision type candidate. Table 5 shows the correspondence between values of the syntax asve_subdivision_method and the subdivision type candidates.

TABLE 5

| asve_subdivision_method | Name of subdivision method |
|---|---|
| 0 | MIDPOINT |
| 1 | LOOP |
| 2 | BUTTERFLY |
| 3 | LS3 |
| 4 . . . 7 | RESERVED |

The syntax asve_subdivision_method may be encoded/decoded via a sequence parameter set. Additionally, the syntax indicating one of the subdivision type candidates may be encoded/decoded in units of frames or patches.

For example, the subdivision type of the base mesh may be determined based on the syntax afve_subdivision_method that is encoded/decoded in units of frames, or the subdivision type of the base mesh may be determined based on the syntax mdu_subdivision_method that is encoded/decoded in units of patches. The subdivision type candidates that can be indicated by the syntax afve_subdivision_method and the syntax mdu_subdivision_method may be identical to those that can be indicated by the syntax asve_subdivision_method.

If the syntax mdu_subdivision_method that is encoded/decoded in units of patch does not present, the syntax afve_subdivision_method that is encoded/decoded in units of frames may be used to determine the subdivision type of the base mesh.

If the syntax afve_subdivision_method that is encoded/decoded in units of frames does not present, the syntax asve_subdivision_method that is encoded/decoded in units of sequences may be used to determine the subdivision type of the base mesh.

Meanwhile, a syntax indicating whether the asps_vdmc_extension structure in Table 3 or Table 4 exists in the bitstream may be encoded and signaled. For example, a value of syntax vdmc_subdivision_enable_flag of 1 indicates that the asps_vdmc_extension structure in Table 3 or Table 4 exists, and a value of syntax vdmc_subdivision_enabled_flag of 0 indicates that the asps_vdmc_extension structure in Table 3 or Table 4 does not exist.

Meanwhile, as in the examples of Table 1 and Table 2, if the subdivision type candidate includes ‘NONE’, whether to subdivide a base mesh or not may be determined based on a syntax indicating the subdivision type candidate (e.g., asve_subdivision_method). If the subdivision type candidate includes ‘NONE’, the encode/decode of the syntax vdmc_subdivision_enable_flag may be omitted, and it is also possible to determine whether to subdivide the base mesh based on the syntax indicating the subdivision type candidate.

As another example, in the first subdivision iteration, the default mesh subdivision type may be applied. In this case, in the first subdivision iteration, encoding/decoding of syntax vdmc_subdivison_method[i] may be omitted.

Alternatively, when mesh subdivision is performed a plurality of times, information indicating whether the mesh subdivision type of each iteration is individually determined may be encoded/decoded. As an example, the information may be a 1-bit flag (e.g., vdmc_subdivision_adaptive_flag). The flag may be encoded/decoded when the number of mesh subdivisions is plural (i.e., when the asve_subdivision_iteration_count is greater than 2). When the flag indicates that the mesh subdivision type of each iteration is determined individually/independently, syntax asve_subdivision_method[i] may be encoded/decoded for each iteration. On the other hand, when the flag indicates that the mesh subdivision type of each iteration is not determined individually/independently, a single asve_subdivision_method may be encoded/decoded. In this case, the mesh subdivision type indicated by asve_subdivision_method may be applied across all iterations. Or, when the flag indicates that the mesh subdivision type of each iteration is not determined individually/independently, a default mesh subdivision type may be applied across all iterations. Here, the default mesh subdivision type is a midpoint subdivision.

Meanwhile, for each subdivision iteration, at least one of the number or types of selectable mesh subdivision type candidates may be different. As an example, a mesh subdivision type used in the previous iteration or the second iteration may be set as unavailable in the current iteration.

Alternatively, midpoint subdivision may be selectable only in the first iteration and may not be selectable from the second iteration onwards.

When the number of selectable mesh subdivision type candidates is different for each subdivision iteration, the number of bits allocated to syntax asve_subdivision_method may be different for each subdivision iteration.

As another example, the encoder/decoder may adaptively determine the mesh subdivision type based on the number of vertices. In this case, encoding/decoding of syntax asve_subdivision_method indicating the mesh subdivision type may be omitted. For example, when the number of vertices included in the mesh is less than A (that is, count(vertex)<A), midpoint subdivision may be selected. Availability and mesh subdivision type may be adaptively determined. On the other hand, when the number of vertices included in the mesh is A or more and less than B (that is, A≤count(vertex)<B), LS3 may be selected. On the other hand, when the number of vertices included in the mesh is B or more (that is, B≤count(vertex)), loop subdivision may be selected.

As another example, a mesh subdivision type may be predefined for each subdivision iteration.

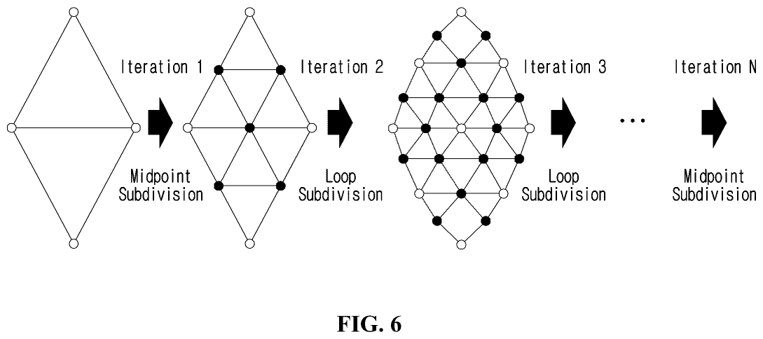

FIG. 6 illustrates an example in which a fixed mesh subdivision type is used for each iteration.

As in the example shown in FIG. 6, in the first iteration, midpoint subdivision may be fixedly used, and in the second and third iterations, loop subdivision may be fixedly used. In addition, in the fourth and subsequent iterations, midpoint subdivision may be fixedly used.

Meanwhile, whether to perform additional mesh subdivision may be determined based on whether a sufficient number of vertices has been generated by mesh subdivision. As an example, the number of vertices generated by mesh subdivision may be compared with a threshold value, and when the number of vertices is greater than or equal to the threshold value, additional mesh subdivision may be set not to be performed. On the other hand, when the number of vertices generated by mesh subdivision is less than the threshold value, mesh subdivision may be additionally performed. Whether or not to perform mesh subdivision is determined by the number of vertices. In this case, encoding/decoding of syntax asve_subdivision_iteration_count indicating the number of mesh subdivisions may be omitted. Alternatively, to prevent excessive number of vertices from being generated by excessive number of subdivision iterations, even when mesh subdivision is determined by the number of vertices, the syntax asve_subdivision_iteration_count indicating the number of subdivision iterations may be encoded/decoded.

Alternatively, the syntax asve_max_subdivision_iteration_count, which indicates the maximum number of subdivisions, may be decoded. And no further mesh subdivisions may be performed if one of the following conditions is satisfied: the number of vertices is greater than or equal to a threshold or the number of subdivision iterations reaches the maximum number of subdivision iterations.

As described above, in the present disclosure, in addition to the midpoint subdivision, it is exemplified that triangulation methods such as the Loop subdivision and the LS3 (Least Squares) subdivision method can be used.

The Loop subdivision represents a subdivision method that adjusts the positions of existing vertices and newly generated vertices. At this time, the existing vertices may be referred to as Even vertices, and the newly generated vertices may be referred to as Odd vertices.

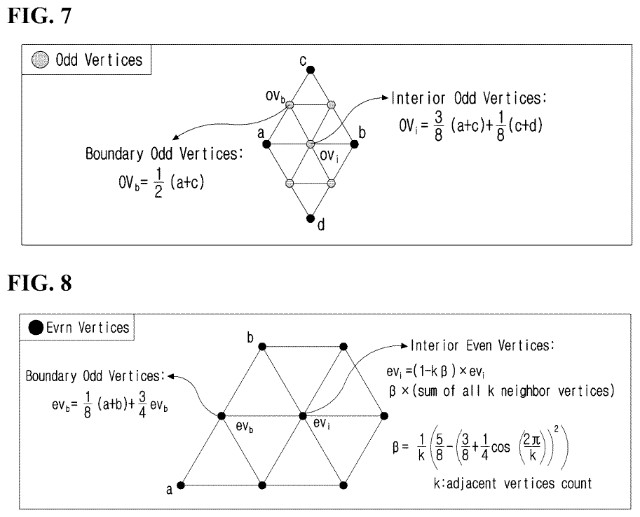

FIGS. 7 and 8 are drawings for explaining a loop subdivision method.

Under a loop subdivision, the positions of existing vertices (even vertices in FIG. 7) and newly generated vertices (odd vertices in FIG. 7) may be derived by a weighted sum operation between the current vertex and adjacent vertices. That is, when loop subdivision is applied, not only the positions of newly generated vertices are derived, but also the positions of existing vertices are revised.

Information on weights assigned to the current vertex and adjacent vertices may be referred to as a weight mask. That is, the weight mask may specify at least one of the number of vertices used in the weighted sum operation, the positions of the vertices, or the weights assigned to each of the vertices.

Meanwhile, under the loop subdivision method, the weight mask applied to the vertices adjacent to the current vertex may be determined based on at least one of whether the current vertex is an even or odd vertex, or the location of the current vertex. Here, the location of the vertex may represent a boundary region, an interior region, or an outlier region. The outlier region indicates a region excluding the boundary region and the interior region.

FIG. 8 illustrates an example of a weight mask applied to adjacent vertices adjacent to the current vertex. As in the example illustrated in FIG. 8, at least one of the number of adjacent vertices used in the weighted sum operation or the weights assigned to the adjacent vertices may be determined based on at least one of whether the current vertex is an even or odd vertex, or whether the current vertex is located at the boundary region or the interior region.

The loop subdivision illustrated in FIG. 7 and FIG. 8 may be effective in implementing smooth surfaces when expressing curves or organic shapes.

The LS3 subdivision may further have a local approximation process for each vertex on a polygonal mesh than the midpoint subdivision or loop segmentation.

The LS3 subdivision has the same complexity as the midpoint subdivision or loop subdivision, but provides particularly high visual quality near extraordinary vertices compared to the midpoint subdivision or loop subdivision.

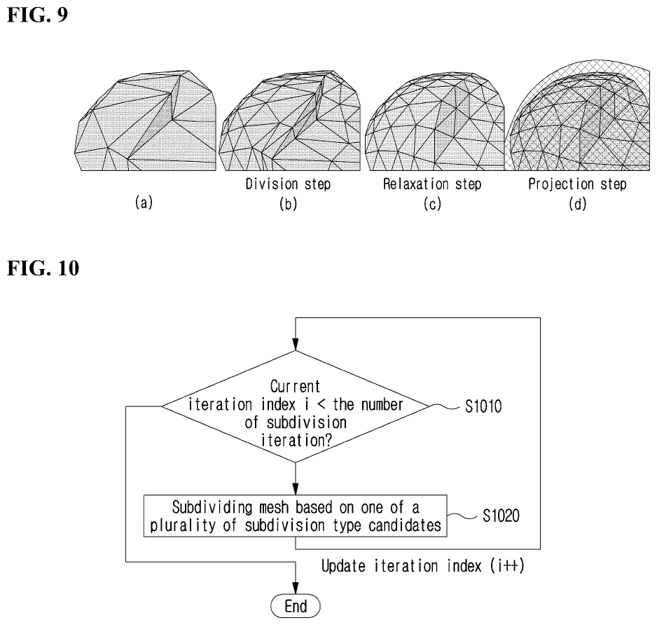

FIG. 9 shows an example in which LS3 subdivision is applied.

LS3 subdivision may include a division step, a relaxation step, and a projection step.

In the division step, new vertices and new surfaces may be generated. Specifically, as in the example illustrated in (b) of FIG. 9, a denser mesh may be obtained through the division step.

In the relaxation step, vertices may be smoothed. Specifically, as in the example illustrated in (c) of FIG. 9, the mesh may be normalized in the relaxation step.

In the projection step, the relaxed vertices may be projected onto an algebraic surface. Specifically, as in the example illustrated in (d) of FIG. 9, the final position of each vertex may be obtained by projecting each vertex onto a least-squares approximation patch.

To implement LS3 subdivision, loop subdivision may also be utilized as a smoothing mask in the relaxation step. By using the loop subdivision mask, each vertex may be locally fitted to the algebraic sphere.

Through this process, the positions and normal values of existing vertices (i.e., even vertices) and newly generated vertices (i.e., odd vertices) may be repeatedly updated in each iteration.

FIG. 10 shows an example in which multiple subdivision type candidates are selectively applied during the encoding process of a dynamic mesh.

As in the example illustrated in FIG. 10, if the current subdivision iteration index i is smaller than the number of subdivision iterations, the mesh may be partitioned based on one of the multiple subdivision type candidates, i.e., the midpoint subdivision, the loop subdivision, and the LS3 subdivision S1010, S1020. Here, i may be an integer including 0.

On the other hand, if the current subdivision iteration index i is equal to or greater than the number of subdivision iterations, the subdivision process of the mesh may be terminated.

Meanwhile, a subdivision type other than the above-described loop subdivision and LS3 subdivision may be used. For example, at least one of the normal subdivision or the PYTHAG subdivision may be used as the subdivision type.

When normal subdivision is applied, a new vertex may be generated at a location where an offset is added to the center of two vertices. At this time, the offset may be set differently depending on the characteristics of the vertex.

Meanwhile, for each of the vertices that constitute the mesh, coordinate information in a two-dimensional image (e.g., texture atlas) must be mapped. Accordingly, when the mesh is subdivided, 2D coordinate information must also be generated for the vertices newly generated by the subdivision.

The method of generating 2D coordinate information may depend on the subdivision type of the base mesh. Specifically, when the subdivision type for the base mesh is determined, the subdivision method for the 2D coordinate may be determined by the determined subdivision type. Here, the 3D space represents a spatial area defined by the coordinates of the vertices, and the 2D coordinate represents a planar area defined by the coordinates of the texture pixels.

For example, if the subdivision type of the base mesh is determined as a midpoint subdivision, the midpoint subdivision may be applied to both 3D space and 2D coordinates. For example, a new vertex may be generated at the center position of two existing vertices in 3D space, and the center positions of two 2D coordinates, assigned to the two existing vertices, may be mapped to the new vertex.

If the subdivision type of the base mesh is determined as loop subdivision, the loop subdivision may be applied to both 3D space and 2D coordinates. Specifically, when the loop subdivision is applied, positions of the existing points and the newly generated points are calculated by the weighted sum operation of adjacent points. That is, the vertex in the 3D space and the corresponding 2D coordinates may be updated by the weighted sum operation.

However, the LS3 subdivision and the normal subdivision include 3D operations based on a normal vector. In the case of PYTHAG subdivision, a cost is highly large compared to it's performance on 2D subdivision. Accordingly, it may not be appropriate to apply the subdivision method, that are not valid or less efficient for the 2D coordinate subdivision, to the points on the 2D plane.

Accordingly, if the subdivision type other than the midpoint and loop subdivision is selected (i.e., LS3 subdivision, normal subdivision or PYTHAG subdivision), for points in 3D space, the selected subdivision may be applied, but for points in 2D plane, the default subdivision type may be applied. For example, the default subdivision type may be a midpoint subdivision. Alternatively, the loop subdivision may be set as the default subdivision type.

In other words, the subdivision type for points in the 3D space may be determined by a syntax (i.e., asve_subdivision_method) explicitly encoded/decoded into/from the bitstream, but, depending on the subdivision type applied to points in 3D space, the subdivision type applied to points in 3D space may also be applied to the points in the 2D plane, or a subdivision type different from the subdivision type applied to points in 3D space may be applied to the points in the 2D plane.

As shown in FIG. 10, if the current subdivision iteration index i is smaller than the number of subdivision iterations, the subdivision type may be determined for the current subdivision iteration.

If the selected subdivision type is a midpoint subdivision (e.g., as in Table 5, when the syntax asve_subdivision_method is 0), the midpoint subdivision may be applied both to 3D vertexes and 2D coordinates.

In addition, if the selected subdivision type is a loop subdivision (e.g., as in Table 5, when the syntax asve_subdivision_method is 1), the loop subdivision may be applied both to 3D vertexes and 2D coordinates.

If the selected subdivision type is not a midpoint subdivision and a loop subdivision (e.g., as in Table 5, when the syntax asve_subdivision_method is greater than 1), for 3D vertexes, the selected subdivision type may be applied, but for 2D coordinates, the default subdivision type may be applied.

On the other hand, the point estimated as an Outlier in the base mesh, the default subdivision type or the subdivision type that is different from the subdivision type applied to 3D vertexes may be applied. For example, the default subdivision type may be applied to point that is estimated as in the BOWTIE area or the degenerate polygon area.

As suggested in the present disclosure, when the number of subdivision type is increased, the syntax (e.g., Table 3 or Table 4) for determining the subdivision type is additionally encoded/decoded. However, as the new subdivision type is applied, the displacement data that needs to be encoded/decoded is reduced, so the overall amount of data to be encoded/decoded is reduced.

Meanwhile, the mesh subdivision method proposed in the present disclosure may be applied not only to base mesh subdivision, but also to other processes performed in an encoder/decoder, such as lifting, geometry parametrization, or texture transfer.

In addition, the mesh subdivision method proposed in the present disclosure may operate during a preprocessing process, a postprocessing process, or an encoding/decoding process in a volumetric codec.

Meanwhile, before performing mesh subdivision, during mesh subdivision process, after performing mesh subdivision, or after reconstructing the mesh, in-loop mesh filtering and re-adjustment processes (hereinafter referred to as in-loop filter) may be performed in the encoder and the decoder.

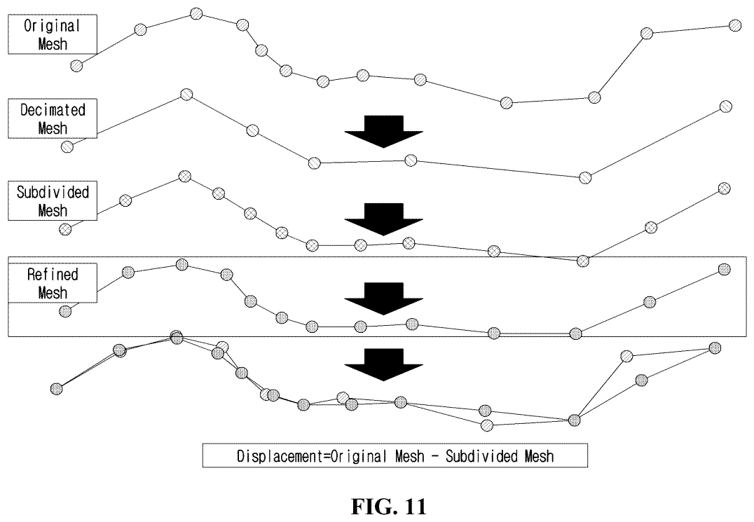

FIG. 11 illustrates a refined mesh output through an in-loop filter.

By readjusting positions of vertices in the mesh subject to in-loop filtering, a refined mesh may be output. In this instance, readjustment of the vertex positions may be performed based on position information of a neighboring vertex group located spatially or temporally adjacent to the vertex.

FIG. 11 illustrates that the in-loop filter is applied to the subdivided mesh. However, the present disclosure is not limited thereto.

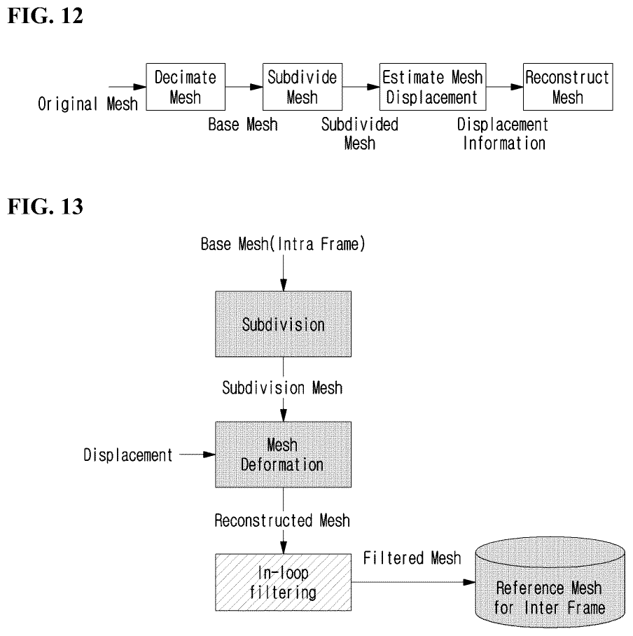

FIG. 12 is a diagram for describing a time point when the in-loop filter is applied.

The in-loop filter may be applied to the base mesh. In other words, before performing mesh subdivision, the in-loop filter may be applied to the base mesh generated by mesh simplification.

In the decoder, after decoding the base mesh, the in-loop filter may be applied to the decoded base mesh.

Meanwhile, when encoding displacement information, whether to apply the in-loop filter to the base mesh may be determined based on at least one of a size of a quantization parameter or the number of repetitions of a mesh subdivision process.

As another example, the in-loop filter may be applied to the subdivided mesh. That is, after the mesh subdivision process is completed and before displacement information is extracted, the in-loop filter may be applied to the subdivided mesh to increase similarity with the original mesh.

In the decoder, after applying mesh subdivision to the base mesh, the in-loop filter may be applied to the subdivided mesh.

Meanwhile, depending on the mesh subdivision type, whether to apply the in-loop filter or at least one of the in-loop filter type may be adaptively determined.

For example, when the mesh subdivision type is midpoint subdivision, a 9-tap filter may be selected as an in-loop filtering technique for the subdivided mesh. Here, the 9-tap filter may refer to a vertex at the center position and eight neighboring vertices adjacent thereto.

On the other hand, when the mesh subdivision type is a butterfly subdivision, a 3-tap filter may be selected as an in-loop filtering technique for the subdivided mesh. Here, the 3-tap filter may refer to the vertex at the center position and two neighboring vertices adjacent thereto.

As another example, the in-loop filter may be applied to the reconstructed mesh. In this instance, depending on the mesh hierarchical partitioning structure (mesh hierarchical partitioning) or coding unit, the in-loop filter may be applied to vertices located in a subdivision boundary region for each subdivision structure. Here, mesh hierarchical partitioning unit may include at least one of a tile, a slice, a subpicture, a coding tree unit, a coding unit, a sub-mesh or a sub-patch.

FIG. 13 illustrates an example in which the in-loop filter is applied to the reconstructed mesh.

As in the example illustrated in FIG. 13, when the in-loop filter is applied to the reconstructed mesh, the mesh to which the in-loop filter is applied may be saved as a reference mesh for inter-prediction.

Alternatively, unlike the example illustrated in FIG. 13, the reconstructed mesh before the in-loop filter is applied may be stored as a reference mesh for inter-prediction.

Meanwhile, at least one of information indicating whether the in-loop filter is applied or a time point when the in-loop filter is applied may be encoded and signaled.

For example, information indicating whether the in-loop filter is applied may be a 1-bit flag.

As an example, information indicating an application position of the in-loop filter may be an index indicating one of a plurality of candidate positions. Alternatively, at each time point, a 1-bit flag indicating whether the in-loop filter is applied may be encoded and signaled. Here, each position may include at least one of a time point when the base mesh is restored, a time point when the base mesh is subdivided, a time point when subdivision is applied to the base mesh, or a time point when the reconstructed mesh is generated.

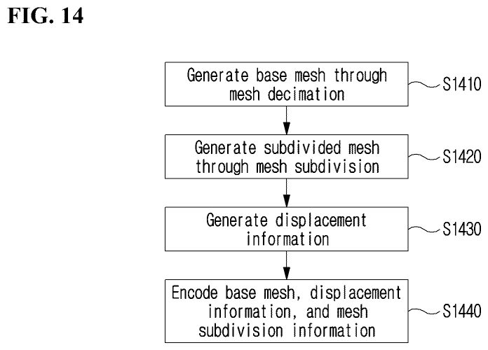

FIG. 14 is a flowchart of a method of encoding the dynamic mesh according to an embodiment of the present disclosure.

Referring to FIG. 14, first, mesh decimation may be performed on an input original mesh to generate a base mesh S1410.

When the base mesh is input, a subdivided mesh may be generated through mesh subdivision S1420. In this instance, as described above, mesh subdivision may be repeatedly performed a plurality of times. In addition, for each iteration, a mesh subdivision type may be independently determined.

Thereafter, displacement information may be generated for the subdivided mesh S1430, and the displacement information and the base mesh may be encoded and signaled S1440. Meanwhile, information about mesh subdivision in the encoder may be encoded into metadata and signaled.

Meanwhile, the in-loop filter may be applied to at least one of the base mesh, the subdivided mesh, or a restored mesh.

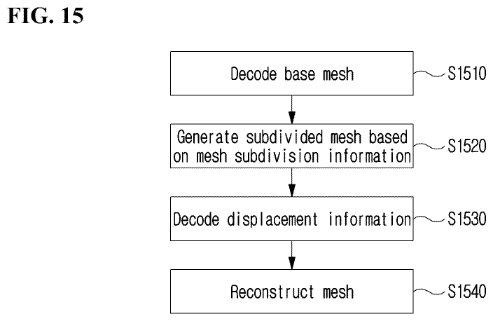

FIG. 15 is a flowchart of a method of decoding the dynamic mesh according to an embodiment of the present disclosure.

Referring to FIG. 15, first, data on the base mesh may be parsed from a bitstream, and the base mesh may be decoded S1510.

Next, mesh subdivision may be applied to the base mesh based on mesh subdivision information signaled from the encoder S1520. The mesh subdivision information may include at least one of whether mesh subdivision has been applied, the number of mesh subdivisions, whether mesh subdivision is determined independently per iteration or the mesh subdivision type.

The displacement information may be decoded S1530, and the decoded displacement information and the subdivided mesh may be combined to generate a reconstructed mesh S1540.

Meanwhile, the in-loop filter may be applied to at least one of the base mesh, the subdivided mesh, or the restored mesh.

Geometric information of each vertex composing a base mesh may be encoded/decoded through an intra mode or an inter mode. Here, geometric information represents the position of a vertex in 3D space.

An intra mode refers to a technique for encoding/decoding the geometric information of a base mesh without referring to a reference image.

An inter mode refers to a technique for encoding/decoding the base mesh of a current image based on the base mesh of a reference image. When an inter mode is applied, a difference between the position of a current vertex in the base mesh of a current image and a position between reference vertexes corresponding in the base mesh of a reference image may be set as a motion vector and information for deriving the motion vector may be encoded/decoded.

Meanwhile, the initial position of an additional vertex may be derived by using two vertexes adjacent to an additional vertex. As an example, when midpoint subdivision method is applied, the initial position of an additional vertex between vertex A and vertex B may be set as the average value or weighted average value of a position of vertex A and a position of vertex B.

The final position (i.e., geometric information) of an additional vertex may be derived by adding displacement information on an additional vertex to the initial position of an additional vertex.

In order to perform subdivision in the same manner as an encoder in a decoder, metadata related to subdivision may be encoded and signaled.

The encoding type of a mesh may be determined in a frame unit. Here, an encoding type may refer to a I type or a P type. A I type frame represents a frame encoded/decoded in an intra mode and a P type frame represents a frame encoded/decoded in an inter mode.

The encoding type of a mesh may be determined by comparing a mesh reconstructed through an intra mode with a mesh reconstructed through an inter mode. As an example, the encoding type of a mesh may be determined by sampling a mesh reconstructed based on an intra mode and a mesh reconstructed based on an inter mode through point cloud and comparing a point cloud coding (PCC) metrix for each.

As an example, the encoding type of a mesh may be determined by comparing the rate-distortion value of a mesh reconstructed through an intra mode (hereinafter, referred to as a first rate-distortion value) with the rate-distortion value of a mesh reconstructed through an inter mode (hereinafter, referred to as a second rate-distortion value). As an example, when a first rate-distortion value is greater than a second rate-distortion value and a difference between a first rate-distortion value and a second rate-distortion value is greater than or equal to a threshold value, the encoding type of a current frame may be determined as a I type. On the other hand, when a first rate-distortion value is greater than a second rate-distortion value and a difference between a first rate-distortion value and a second rate-distortion value is less than a threshold value, the encoding type of a current frame may be determined as a P type.

When a first rate-distortion value is equal to or smaller than a second rate-distortion value, the encoding type of a current frame may be determined as a P type.

On the other hand, although a frame is designed as a P type frame, it may be encoded/decoded as a I type frame due to distortion of a reconstructed mesh within a reference frame.

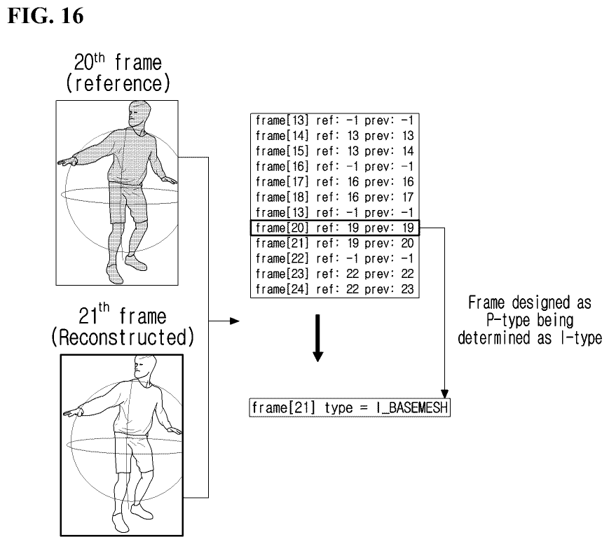

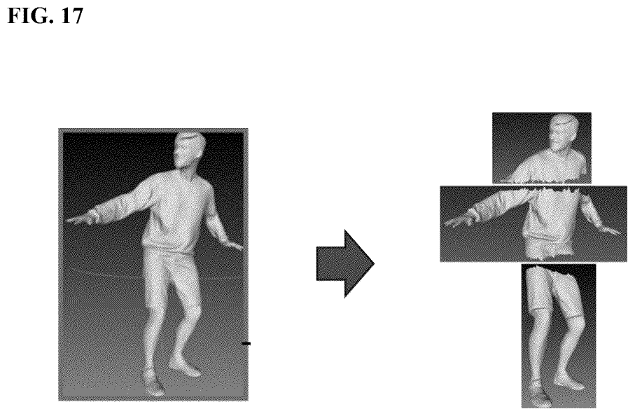

As an example, as in an example shown in FIG. 16, for a test sequence designed to encode/decode a plurality of frames in a unit of one I type frame and two P type frames (i.e., IPP image), a frame in the P type order may be encoded/decoded as a I type due to distortion of a reconstructed mesh of a previous frame. As a frame considered as a P type is encoded/decoded as a I type, a problem occurs that the amount of data to be encoded/decoded increases unexpectedly.

In order to solve the problem, the present disclosure proposes a method for partitioning a mesh into a plurality of regions and independently determining an encoding type for each partitioned region.

Specifically, when an encoding type is determined in a frame unit, but the encoding type of a frame is determined as a I type, a mesh may be partitioned into a plurality of regions and an encoding type may be determined for each partitioned region.

FIG. 17 shows an example in which a mesh is partitioned into a plurality of regions.

Each partitioned region may be referred to as a sub-mesh. Independent encoding/decoding may be supported between sub-meshes. Here, when a sub-mesh is independently encoded/decoded, it represents that encoding/decoding is performed without referring to information of other sub-meshes.

Meanwhile, when the encoding type of a frame is determined as a P type, a mesh may be encoded/decoded without omitting a process of partitioning a mesh into a plurality of sub-meshes. In other words, a mesh may be partitioned into a plurality of sub-meshes only when the encoding type of a frame is determined as a I type.

In addition, since a first frame in the group of frame (GOF) must be set as a l type, a sub-mesh partition structure may not be applied even when a current frame is the first frame of GOF.

Through a sub-mesh partition structure proposed in the present disclosure, a data ratio encoded/decoded in an inter mode (i.e., a P type) may be increased. Through this, a transmission bandwidth may be reduced by reducing mesh and displacement information that needs to be encoded/decoded.

Meanwhile, the encoding type of a sub-mesh may also be determined by comparing PCC metrixes for each of a sub-mesh reconstructed based on an intra mode and a sub-mesh reconstructed based on an inter mode.

Information on the partition structure of a mesh may be encoded and signaled. The information may include at least one of information indicating whether a mesh is partitioned, information on the number of sub-meshes, information on the position of a sub-mesh or information on the size of a sub-mesh.

Information indicating whether a mesh is partitioned may be a 1-bit flag. As an example, when the value of the flag is 1, it represents that a mesh may be partitioned into a plurality of sub-meshes. On the other hand, when the value of the flag is 0, it represents that a mesh is not partitioned.

Information on the number of sub-meshes represents the number of sub-meshes generated by partitioning a mesh. As an example, a syntax showing a value obtained by subtracting 1 from the number of sub-meshes may be encoded/decoded.

Meanwhile, when the number of sub-meshes is 1, it represents that a mesh is not partitioned. Accordingly, when the number of sub-meshes is 1, encoding/decoding of the position information and size information of a sub-mesh may be omitted.

The position information of a sub-mesh represents the position of a bounding box corresponding to a sub-mesh. Specifically, position information may represent the coordinate of at least one vertex forming a bounding box. When a plurality of sub-meshes exist, position information may be encoded/decoded for each of a plurality of sub-meshes. Alternatively, position information may be encoded/decoded only for the remaining sub-meshes excluding a first or last sub-mesh among a plurality of sub-meshes.

As an example, information on the position of a sub-mesh may represent the coordinate of at least one vertex forming a bounding box corresponding to a sub-mesh. Information on the size of a sub-mesh may represent at least one of the width, height or depth of the bounding box.

Meanwhile, information on a sub-mesh partition structure may be encoded/decoded in a predetermined unit. Here, a predetermined unit may be a sequence or frame unit. As an example, when a predetermined unit is a sequence unit, a sub-mesh partition structure in a plurality of frames referring to the sequence may be mutually identical. In other words, the sub-mesh partition structure of each of a plurality of frames whose encoding type is a I type may be mutually identical.

Alternatively, when a predetermined unit is a frame unit, the sub-mesh partition structures of each frame may be independently determined. In other words, the mesh partition structure of each frame whose encoding type is a I type may be mutually independent.

When a sub-mesh partition structure is determined in a predetermined unit, information showing whether it is required to update a sub-mesh partition structure in a previous period may be encoded and signaled. As an example, the information may be a flag showing whether it is required to update the sub-mesh partition structure of a previous frame.

When the value of the flag is 1, it represents that it is required to update a sub-mesh partition structure in a previous period. In this case, for a current unit (e.g., a current sequence or a current frame), updated sub-mesh partition structure-related information may be encoded/decoded.

On the other hand, when the value of the flag is 0, it represents that it is not required to update the sub-mesh partition structure of a previous frame. In this case, for a current unit, the encoding/decoding of sub-mesh partition structure-related information may be omitted and a sub-mesh partition structure in a previous unit (e.g., a previous sequence or a previous frame) may be reused in a current unit.

When sub-mesh partition structure-related information is determined in a frame unit, sub-mesh partition structure-related information may be encoded and signaled only when the encoding type of a frame is a I type.

Meanwhile, when one mesh is partitioned into a plurality of sub-meshes, distortion due to a cross section may occur at a boundary between sub-meshes.

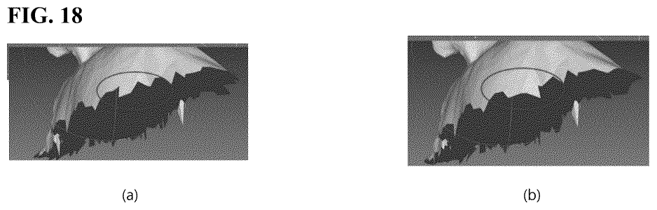

FIG. 18 is a diagram for describing an example in which distortion due to a cross-section occurs at a boundary between sub-meshes.

When a mesh is cut vertically along a y-axis, as in an example shown in FIGS. 18 (a) and (b), a mesh shape at a cross section may change.

Accordingly, distortion due to a cross section may occur when calculating a PCC matrix for determining the encoding type of a sub-mesh. In order to solve the problem, the size of a bounding box may be adjusted when determining an encoding type for a sub-mesh.

As an example, the size of a bounding box may be enlarged in an outward direction of a current sub-mesh.

An enlarged bounding box may include not only a current sub-mesh, but also a portion of an adjacent sub-mesh. A PCC matrix may be calculated by sampling only a current sub-mesh within an enlarged bounding box. Since an enlarged bounding box includes not only a current sub-mesh, but also a portion of an adjacent sub-mesh, distortion due to a cross section may not occur at the boundary of a current sub-mesh. Accordingly, distortion due to a cross section may be reduced when calculating a PCC matrix.

Alternatively, the size of a bounding box may be reduced in the inward direction of a current sub-mesh. A reduced bounding box may not include a portion corresponding to the boundary of a current sub-mesh. The PCC matrix of a current sub-mesh may be calculated based on vertexes included in a reduced bounding box within a current sub-mesh. In other words, only vertexes included in a reduced bounding box within a current sub-mesh may be sampled and vertexes not included in a reduced bounding box (i.e., vertexes forming a cross section) may not be sampled. Accordingly, when calculating a PCC matrix for determining an encoding type, distortion due to a cross section may be reduced.

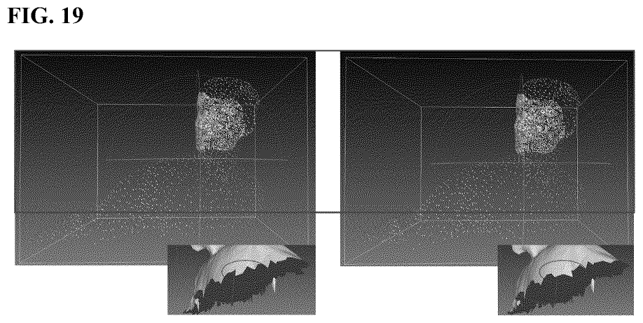

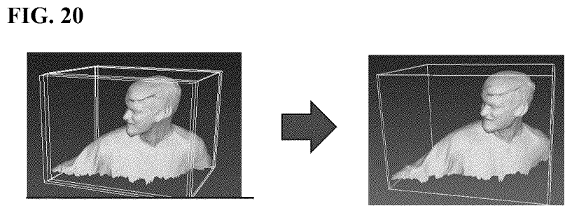

FIG. 19 shows an example in which the size of a bounding box is adjusted.

In FIG. 19, it is illustrated that the size of a bounding box is adjusted by adjusting the z-axis coordinate of a bounding box.

The size adjustment of a bounding box may be determined according to the partition direction of a mesh. As an example, when a mesh is partitioned into a plurality of sub-meshes along a z-axis direction, the size of a bounding box may be adjusted only in a z-axis direction.

Meanwhile, a bounding box whose size is adjusted may be used only when determining an encoding type. In other words, the encoding type of a sub-mesh is determined based on a bounding box whose size is adjusted, but a sub-mesh to be encoded/decoded may be determined based on a bounding box before a size is adjusted.

Information related to the size adjustment of a bounding box may be encoded and signaled. The information may include at least one of information showing whether the size of a bounding box is adjusted and size adjustment offset information.

Information showing whether the size of a bounding box is adjusted may be a 1-bit flag. As an example, when the flag is 1, it represents that the size of a bounding box is adjusted. In this case, size adjustment offset information may be additionally encoded and signaled. On the other hand, when the flag is 0, it represents that the size of a bounding box is not adjusted.

Size adjustment offset information may represent a size difference between a bounding box before size adjustment and a bounding box after size adjustment.

When a sub-mesh partition structure is determined in a unit of a plurality of frames, the distortion value of a PCC matrix may increase due to a motion. In other words, a bounding box has a fixed position for a plurality of frames, but when a motion occurs in a sub-mesh within it, the distortion value of a PCC matrix occurs.

In order to solve the problem, the position of a bounding box for a current frame may be adjusted by referring to the position of a bounding box in a previous frame.

FIG. 20 shows an example in which the position of a bounding box is adjusted.

The bounding box of a sub-mesh in a current frame may be adjusted to a position where the bounding box of a corresponding sub-mesh in a previous frame is moved in parallel.

Alternatively, the bounding box of a sub-mesh in a current frame may be adjusted to a position where the bounding box of a corresponding sub-mesh in a previous frame is rotated based on a predetermined reference axis.

As above, the position of a bounding box may be adjusted to supplement an error when calculating a PCC matrix.

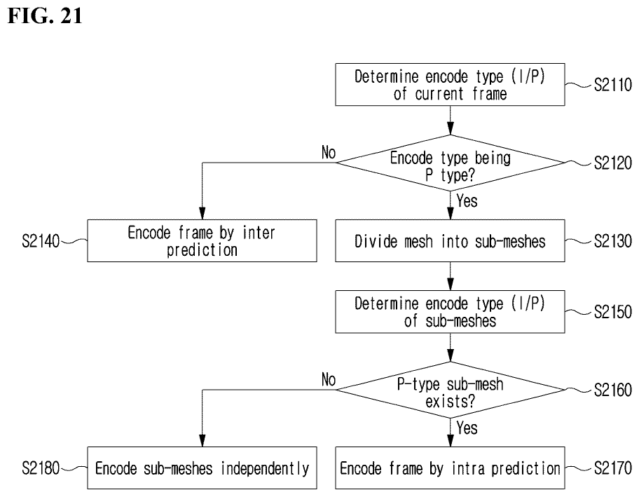

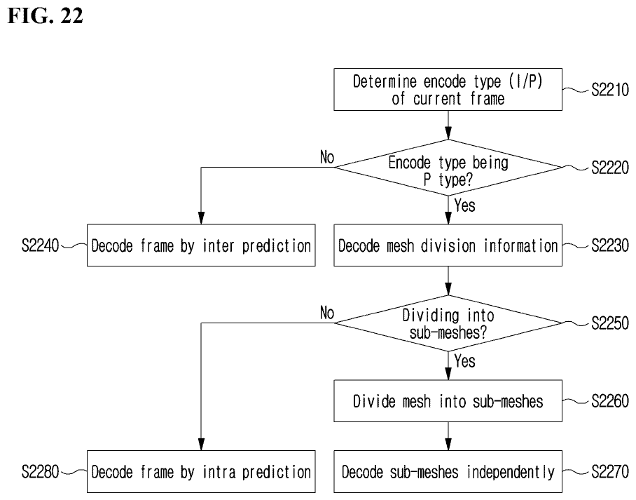

FIGS. 21 and 22 are an example of a mesh encoding/decoding method according to an embodiment of the present disclosure.

FIG. 21 shows an operation in an encoder and FIG. 22 shows an operation in a decoder.

First, an encoder determines the encoding type of a current frame S2110.

When the encoding type of a current frame is a P type S2120, a mesh may be encoded through inter prediction without partitioning a mesh S2140.

On the other hand, when the encoding type of a current frame is a I type S2120, a mesh is partitioned into a plurality of sub-meshes S2130.

Then, an encoding type for each of a plurality of sub-meshes is determined S2150.

When there is a sub-mesh whose encoding type is a P type among a plurality of sub-meshes S2160, each sub-mesh may be encoded independently S2170. On the other hand, when there is no sub-mesh whose encoding type is a P type, a mesh may be encoded through intra prediction without partitioning a mesh S2180.

Meanwhile, an encoder may encode and signal at least one of information showing the encoding type of a current frame, sub-mesh partition structure-related information and information on the encoding type of a sub-mesh.

A decoder determines the encoding type of a current frame S2210.

When the encoding type of a current frame is a P type S2220, a mesh may be decoded through inter prediction without partitioning a mesh S2240.

On the other hand, when the encoding type of a current frame is a I type S2220, information showing whether a mesh is partitioned is decoded S2230.

When the partition information indicates that a mesh is partitioned into a plurality of sub-meshes S2250, a mesh is partitioned into a plurality of sub-meshes S2260 and each of a plurality of sub-meshes is independently decoded S2270.

On the other hand, when the partition information indicates that a mesh is not partitioned S2250, a mesh may be decoded through intra prediction without partitioning a mesh S2280.

Meanwhile, a mesh may be partitioned into sub-meshes only when a current frame is not a first frame in GOF (i.e., a first I frame). In other words, when a current frame is a first frame in GOF, encoding/decoding of mesh partition information may be omitted even when the encoding mode of a current frame is a I type.

According to the present disclosure, by providing a method of subdividing a base mesh generated through mesh decimation, restoration quality may be improved while reducing the amount of data to be encoded/decoded.

According to the present disclosure, there is an effect of improving objective/subjective image quality by subdividing a base mesh based on a plurality of mesh subdivision type candidates.

According to the present disclosure, an encoding/decoding method for partitioning a mesh into a plurality of sub-meshes may be provided.

According to the present disclosure, data encoded/decoded as a P type may be increased by determining an encoding type for each sub-mesh.

According to the present disclosure, data encoded/decoded as a P type may be increased by adjusting the size and/or position of a bounding box for determining an encoding type.

The present disclosure has an effect of improving objective/subjective image quality by variably setting a mesh subdivision type for each subdivision iteration.

The present disclosure has an effect of improving objective/subjective image quality by providing a method of determining a subdivision type of 3D vertexes and 2D texture coordinates.

The effects that may be obtained from the present disclosure are not limited to the effects mentioned above, and other effects not mentioned herein may be clearly understood by those skilled in the art from the above description.

A name of syntax elements introduced in the above-described embodiments is only temporarily given to describe embodiments according to the present disclosure. Syntax elements may be referred to as names different from those proposed in the present disclosure.

A component described in illustrative embodiments of the present disclosure may be implemented by a hardware element. For example, the hardware element may include at least one of a digital signal processor (DSP), a processor, a controller, an application-specific integrated circuit (ASIC), a programmable logic element such as an FPGA, a GPU, other electronic device, or a combination thereof. At least some of functions or processes described in illustrative embodiments of the present disclosure may be implemented by software and the software may be recorded in a recording medium. A component, a function, and a process described in illustrative embodiments may be implemented by a combination of hardware and software.

A method according to an embodiment of the present disclosure may be implemented by a program which may be performed by a computer and the computer program may be recorded in a variety of recording media such as a magnetic storage medium, an optical reading medium, a digital storage medium, etc.

A variety of technologies described in the present disclosure may be implemented by a digital electronic circuit, computer hardware, firmware, software, or a combination thereof. The technologies may be implemented by a computer program product, that is, a computer program tangibly implemented on an information medium or a computer program processed by a computer program (for example, a machine-readable storage device (for example, a computer-readable medium) or a data processing device) or a data processing device or implemented by a signal propagated to operate a data processing device (for example, a programmable processor, a computer, or a plurality of computers).

Computer program(s) may be written in any form of a programming language including a compiled language or an interpreted language and may be distributed in any form including a stand-alone program or module, a component, a subroutine, or other unit suitable for use in a computing environment. A computer program may be performed by one computer or a plurality of computers which are located at one site or spread across multiple sites and are interconnected by a communication network.

An example of a processor suitable for executing a computer program includes a general-purpose and special-purpose microprocessor and one or more processors of a digital computer. In general, a processor receives an instruction and data in a read-only memory (ROM), a random-access memory (RAM), or both memories. A component of a computer may include at least one processor for executing an instruction and at least one memory device for storing an instruction and data. In addition, a computer may include one or more mass storage devices for storing data, for example, a magnetic disk, a magneto-optical disc, or an optical disc, or may be connected to the mass storage device to receive and/or transmit data. An example of an information medium suitable for implementing a computer program instruction and data includes a semiconductor memory device (for example, a magnetic medium such as a hard disk, a floppy disk, or a magnetic tape), an optical medium such as a compact disc read-only memory (CD-ROM), a digital video disc (DVD), etc., a magneto-optical medium such as a floptical disk, and a ROM, a RAM, a flash memory, an EPROM (Erasable Programmable ROM), an EEPROM (Electrically Erasable Programmable ROM) and other known computer readable medium. A processor and a memory may be complemented or integrated by a special-purpose logic circuit.

A processor may execute an operating system (OS) and one or more software applications executed in an OS. A processor device may also respond to software execution to access, store, manipulate, process and generate data. For simplicity, a processor device is described in the singular, but those skilled in the art may understand that a processor device may include a plurality of processing elements and/or various types of processing elements. For example, the processor device may include a plurality of processors or a processor and a controller. In addition, the processor device may configure a different processing structure like parallel processors. In addition, a computer readable medium means all media which may be accessed by a computer and may include both a computer storage medium and a transmission medium.

The present disclosure includes detailed description of various detailed implementation examples. However, it should be understood that the detailed content does not limit a scope of claims or an invention proposed in the present disclosure and describes features of a specific illustrative embodiment.

Features which are individually described in illustrative embodiments of the present disclosure may be implemented by a single illustrative embodiment. Conversely, a variety of features described regarding a single illustrative embodiment in the present disclosure may be implemented by a combination or a proper sub-combination of a plurality of illustrative embodiments. Further, in the present disclosure, the features may be operated by a specific combination and may be described as the combination is initially claimed, but in some cases, one or more features may be excluded from a claimed combination or a claimed combination may be changed in a form of a sub-combination or a modified sub-combination.

Likewise, although an operation is described in specific order in a drawing, it should not be understood that it is necessary to execute operations in specific turn or order or it is necessary to perform all operations in order to achieve a desired result. In a specific case, multitasking and parallel processing may be useful. In addition, it should not be understood that a variety of device components should be separated in illustrative embodiments of all embodiments and the above-described program component and device may be packaged into a single software product or multiple software products.

Illustrative embodiments disclosed herein are just illustrative and do not limit a scope of the present disclosure. Those skilled in the art may recognize that illustrative embodiments may be variously modified without departing from claims and a spirit and a scope of equivalents thereto.

Accordingly, the present disclosure includes all other replacements, modifications and changes belonging to the following claim.

What is claimed is:

1. A method of decoding a dynamic mesh, comprising:
decoding a base mesh;
subdividing the base mesh;
decoding displacement information; and
reconstructing a mesh by applying the displacement information to a subdivided mesh,
wherein a 3-dimensional subdivision type of the base mesh is determined based on mesh subdivision information decoded from a bitstream, and
wherein a 2-dimensional subdivision type for a 2D coordinate is determined based on the 3D subdivision type for the base mesh.

2. The method of claim 1, wherein when the 3D subdivision type is a midpoint subdivision or the loop subdivision, the 2D subdivision type is the same as the 3D subdivision type.

3. The method of claim 2, wherein when the 3D subdivision type is not the midpoint subdivision and the loop subdivision, the 2D subdivision type is determined as a default subdivision type.

4. The method of claim 3, wherein the default subdivision type is the midpoint subdivision.

5. The method of claim 1, wherein the mesh subdivision information comprises an index specifying one of a plurality of mesh subdivision type candidates.

6. The method of claim 5, wherein the plurality of mesh subdivision type candidates comprises at least one of a midpoint subdivision, a loop subdivision, a LS3 subdivision, a normal subdivision or a PYTHAG subdivision.

7. The method of claim 5, wherein subdivision iteration information indicating a number of subdivision iterations of a mesh is further decoded from the bitstream, and
wherein when a current subdivision iteration index is less than the number of subdivision iterations indicated by the subdivision iteration information, the mesh subdivision information is decoded.

8. A method of encoding a dynamic mesh, comprising:
generating a base mesh through a mesh decimation;
subdividing the base mesh;
extracting displacement information for a subdivided mesh; and
encoding the base mesh and the displacement information,
wherein mesh subdivision information indicating a 3-dimensional subdivision type of the base mesh is encoded into a bitstream, and
wherein a 2-dimensional subdivision type for a 2D coordinate is determined based on the 3D subdivision type for the base mesh.

9. The method of claim 8, wherein when the 3D subdivision type is a midpoint subdivision or the loop subdivision, the 2D subdivision type is the same as the 3D subdivision type.

10. The method of claim 9, wherein when the 3D subdivision type is not the midpoint subdivision and the loop subdivision, the 2D subdivision type is determined as a default subdivision type.

11. The method of claim 10, wherein the default subdivision type is the midpoint subdivision.

12. The method of claim 8, wherein the mesh subdivision information comprises an index specifying one of a plurality of mesh subdivision type candidates.

13. The method of claim 12, wherein the plurality of mesh subdivision type candidates comprises at least one of a midpoint subdivision, a loop subdivision, a LS3 subdivision, a normal subdivision or a PYTHAG subdivision.

14. The method of claim 12, wherein subdivision iteration information indicating a number of subdivision iterations of a mesh is further encoded into the bitstream, and
wherein when a current subdivision iteration index is less than the number of subdivision iterations indicated by the subdivision iteration information, the mesh subdivision information is encoded.

15. A non-transitory computer readable recording medium storing instruction for implementing a method of encoding a dynamic mesh, wherein the method comprising:
generating a base mesh through a mesh decimation;
subdividing the base mesh;
extracting displacement information for a subdivided mesh; and
encoding the base mesh and the displacement information,
wherein mesh subdivision information indicating a 3-dimensional subdivision type of the base mesh is encoded into a bitstream, and
wherein a 2-dimensional subdivision type for a 2D coordinate is determined based on the 3D subdivision type for the base mesh.
